(19) United States
(12) Patent Application Publication
(10) Pub. No.: US 2011/0303192 A1
(43) Pub. Date: Dec. 15, 2011

(54) INTERNAL COMBUSTION ENGINE WITH SEALING PROTECTION FOR A FUEL INJECTION VALVE

(76) Inventors: Klaus Jung, Waiblingen (DE); Martin Scheffel, Vaihingen (DE)

(21) Appl. No.: 12/305,119

(22) PCT Filed: Apr. 30, 2008
(86) PCT No.: PCT/EP2008/055328

§ 371 Date: Feb. 25, 2009

(30) Foreign Application Priority Data
May 2, 2007 (DE) 10 2007 020 506.8
Apr. 30, 2008 (DE) 10 2008 001 489.3

(51) Int. Cl. F02M 61/16; F02M 69/04

(52) U.S. Cl. 123/445

(57) ABSTRACT

An internal combustion engine includes a combustion chamber and a fuel injection valve that injects fuel directly into the combustion chamber, the fuel injection valve being situated in a cylinder head, and an annular sealing element being situated between the fuel injection valve and the cylinder head in order to seal the combustion chamber, and a shielding ring being situated between the sealing element and the combustion chamber in an axial direction of the fuel injection valve, the shielding ring being characterized in that it has a round cross-section or a cross-section that is rounded radially outward.

### FIELD OF THE INVENTION

The present invention relates to an internal combustion engine having a sealing protection for a seal of a fuel injection valve.

### BACKGROUND INFORMATION

Internal combustion engines are known in various embodiments from the prior art. In particular, internal combustion engines are known that use a fuel injection valve to inject fuel directly into a combustion chamber. For this purpose, the fuel injection valve is situated in a cylinder head and injects the fuel directly into the combustion chamber. An annular seal, for example a Teflon ring, is used here to create a seal between the fuel injection valve and the cylinder head. Because very high temperatures obtain in the combustion chamber during operation, and the sealing ring is situated between the fuel injection valve and the cylinder head, relatively close to the combustion chamber, negative thermal effects may act on the sealing ring. It has been determined that after only a short operating time of the internal combustion engine, rust particles may become situated in a gap between the fuel injection valve and the cylinder head at the combustion chamber side, partly insulating the seal thermally from the combustion chamber. However, in practice this deposition of rust particles is not uniform, so that this rust particle deposition cannot provide reliable protection for the seal.

In addition, from DE 10 2005 019 313 a fuel injection valve is known in which a shielding ring provided with a slit is situated on the fuel injection valve. The shielding ring is situated between the seal and the combustion chamber, and has a rectangular cross-section. However, this measure cannot ensure complete shielding of the sealing element, because complete protection of the sealing element is not possible due to the slit and due to the rectangular cross-section.

### SUMMARY

In contrast, the internal combustion engine according to example embodiments of the present invention has the advantage that it provides excellent shielding for a sealing element situated between a fuel injection valve and a cylinder head, so that the sealing element has a very long life span. Here, the shielding is situated between the sealing element and a combustion chamber of the internal combustion engine, in the axial direction of the fuel injection valve. The shielding has an annular shape, also having a round cross-section, or a cross-section that is rounded radially outward. The use of the round or rounded cross-section of the shielding ring makes it possible for the shielding ring to be seated securely between the cylinder head wall and an external wall of the housing of the fuel injection valve. This ensures that during operation of the internal combustion engine, processes occurring in the combustion chamber will not have a negative influence on the sealing element, because the sealing element is protected by the shielding ring. In addition, the design with a round cross-section ensures that linear contact is achieved between the cylinder head wall and the fuel injection valve.

According to example embodiments of the present invention, the shielding ring is made of wire. In this manner, the shielding ring can be provided in a particularly simple and economical fashion. In addition, a shielding ring made of wire is also easy to install. Alternatively, the shielding ring is made of a material that can withstand high temperatures, in particular a plastic that can withstand adhesion temperatures.

Preferably, the shielding ring is situated in a groove formed in the fuel injection valve. In this manner, in particular the cylinder head wall can be constructed very simply, e.g. as a cylindrical bore.

Particularly preferably, the sealing element is situated in a first groove formed in the fuel injection valve, and the shielding ring is situated in a second groove formed in the fuel injection valve. This prevents the shielding ring from coming into direct contact with the sealing element. However, for this purpose two separate grooves must be provided in the fuel injection valve.

According to example embodiments of the present invention, the shielding ring and the sealing element are situated in a common groove in the fuel injection valve, at a distance from one another. This makes it possible for only one groove to be required to accommodate the shielding ring and the sealing element in the fuel injection valve.

Particularly preferably, the shielding ring has a closed annular shape. This may be achieved for example by connecting the free ends of the shielding ring, e.g. by welding or gluing. This prevents in particular problems at a gap between the fuel injection valve and the cylinder head wall. Alternatively, the shielding ring has an annular shape that is open, i.e. that has a radial slit. This makes it possible to expand the shielding ring during installation.

According to example embodiments of the present invention, the shielding ring is situated in a groove that is formed in the cylinder head. This makes it possible to install the shielding ring before installing the fuel injection valve in the cylinder head.

According to example embodiments of the present invention, the shielding ring is situated partly in a groove formed in the cylinder head and partly in a groove formed in the fuel injection valve. In other words, the shielding ring is seated partially in the wall of the cylinder head and partially in the housing of the fuel injection valve, and grooves having corresponding depths are formed in each case for this purpose. The grooves preferably have a depth corresponding to a radius of the shielding ring with round cross-section.

Preferably, a diameter of the shielding ring is equal to a thickness of the sealing element in the radial direction.

It is particularly advantageous to provide the shielding ring with a thin-walled C-shaped profile that is convexly curved radially outward, so that it inwardly encloses an open hollow space. This embodiment of the shielding ring represents a variation that saves material while also offering a high degree of elasticity and shielding effectiveness.

According to example embodiments of the present invention, an expanded gap is provided in a side of the sealing element facing away from the combustion chamber, said gap being capable of accommodating excess material or wear debris or the like from the sealing element.

In the following, exemplary embodiments of the present invention are described in detail with reference to the accompanying drawing.

### BRIEF DESCRIPTION OF THE DRAWINGS

FIG. 1 shows a schematic sectional view of an internal combustion engine according to an exemplary embodiment of the present invention,

FIG. 2 shows a schematic sectional view of an internal combustion engine according to an exemplary embodiment of the present invention,

FIG. 3 shows a schematic sectional view of an internal combustion engine according to an exemplary embodiment of the present invention,

FIG. 4 shows a schematic sectional view of an internal combustion engine according to an exemplary embodiment of the present invention, and

FIGS. 5 through 9 show five additional alternative exemplary embodiments of shielding rings having a cross-section that is rounded radially outward.

### DETAILED DESCRIPTION

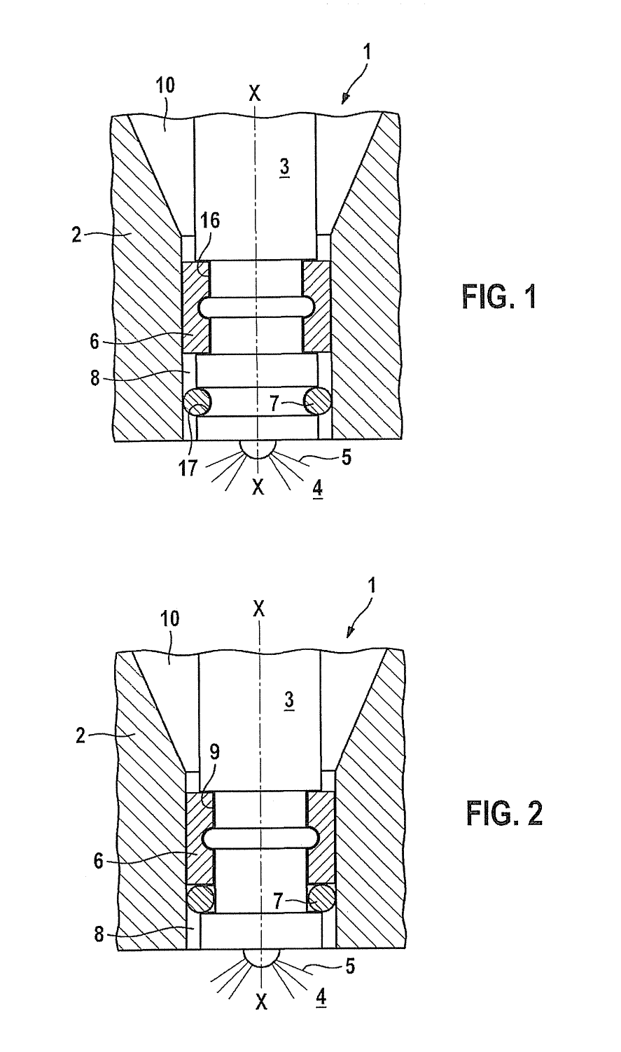

In the following, an internal combustion engine according to an exemplary embodiment of the present invention is described in detail with reference to FIG. 1.

FIG. 1 shows internal combustion engine 1 in a partial, highly schematic view. Reference character 2 designates a cylinder head, and reference character 3 designates a fuel injection valve. Fuel injection valve 3 injects fuel 5 directly into a combustion chamber 4 that is shown schematically in FIG. 1. Fuel injection valve 3 is fixed in cylinder head 2 and has a sealing element 6 that may for example be a Teflon ring. Sealing element 6 is situated in a first groove 16 in fuel injection valve 3. Sealing element 6 thus seals the combustion chamber in the area of fuel injection valve 3. Because sealing element 6 is situated relatively close to the combustion chamber, it is possible for negative influences to act on sealing element 6 during operation of the internal combustion engine, through gap 8 between cylinder head 2 and fuel injection valve 3. In order to prevent this, a shielding ring 7, having a round cross-section, is situated in gap 8. Shielding ring 7 is made of a wire material, and is situated in a second annular groove 17.

Shielding ring 7 is therefore situated between sealing element 6 and combustion chamber 4 in the axial direction X-X of the fuel injection valve. In addition, an accommodating space 10, for accommodating wear debris or the like, is situated on a side of sealing element 6 that faces away from the combustion chamber. Accommodating space 10 is formed for example by an expanded gap between cylinder head 2 and fuel injection valve 3.

Shielding ring 7, having a round cross-section, has the advantage that it enables a linear seal at the cylinder head and a linear seal at fuel injection valve 3. In this way, it can be ensured that influences from combustion chamber 4 do not act directly on sealing element 6. In this way, sealing element 6 can have a very long life span. In particular, in this way sealing element 6 can be protected from direct action of the combustion chamber gases.

Because a predetermined spacing exists between shielding ring 7 and sealing element 6, sealing element 6 and shielding ring 7 do not come into contact with each other. In particular, this also makes it possible to prevent damage to the sealing element due to thermal conduction.

In the following, an internal combustion engine 1 according to an exemplary embodiment of the present invention is described in detail with reference to FIG. 2. Identical or functionally identical parts have been provided with the same reference characters as in the first exemplary embodiment.

Differing from the first exemplary embodiment, in the second exemplary embodiment sealing element 6 and shielding ring 7 are situated in a common groove 9 that is provided in fuel injection valve 3. Sealing element 6 and shielding ring 7 are situated immediately adjacent to one another in groove 9. This enables in particular a simpler, more economical manufacture, because only one common groove has to be manufactured for sealing element 6 and for shielding ring 7 in the housing area of fuel injection valve 3. It is to be noted that a predetermined spacing may also be present between sealing element 6 and shielding ring 7 in common groove 9. In other respects this exemplary embodiment corresponds to the preceding exemplary embodiment, so that reference is made to the description of that embodiment.

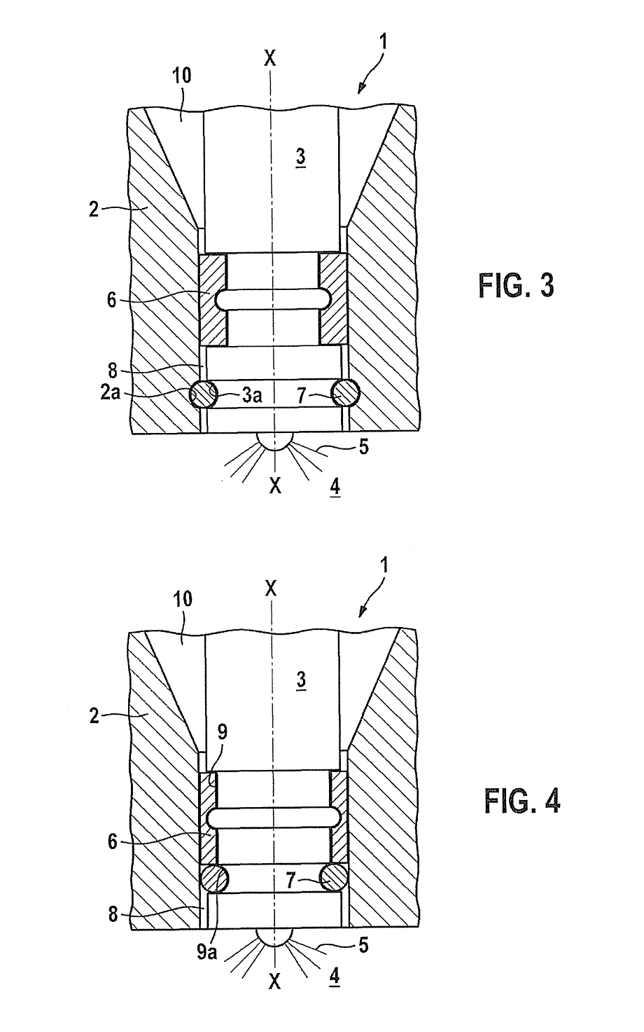

In the following, an internal combustion engine 1 according to an exemplary embodiment of the present invention is described with reference to FIG. 3; identical or functionally identical parts have again been provided with the same reference characters as in the preceding exemplary embodiments. The third exemplary embodiment is similar to the first exemplary embodiment, but differs in that shielding ring 7 is situated both partly in cylinder head 2 and partly in fuel injection valve 3. For this purpose, in cylinder head 2 a groove 2a is fashioned, and a groove 3a is fashioned in fuel injection valve 3. The two grooves 2a, 3a are situated at the same height in the axial direction X-X of fuel injection valve 3. The depth of the two grooves 2a, 3a is selected such that each groove accommodates approximately half of shielding ring 7. In other words, the depth of grooves 2a and 3a is approximately equal to the radius of shielding ring 7, which has a round cross-section. This measure achieves in particular an improved fixing of shielding ring 7 in the internal combustion engine.

FIG. 4 shows an exemplary embodiment, in which identical or functionally identical parts have again been provided with reference characters identical to those in the preceding exemplary embodiments. The fourth exemplary embodiment corresponds substantially to the second exemplary embodiment, but in the fourth exemplary embodiment a recess 9a is provided in common groove 9. Shielding ring 7 is situated in recess 9a. Recess 9a, in the shape of a groove, runs around the entire circumference. In other respects, this exemplary embodiment corresponds to the preceding exemplary embodiment, so that reference is made to the description provided there.

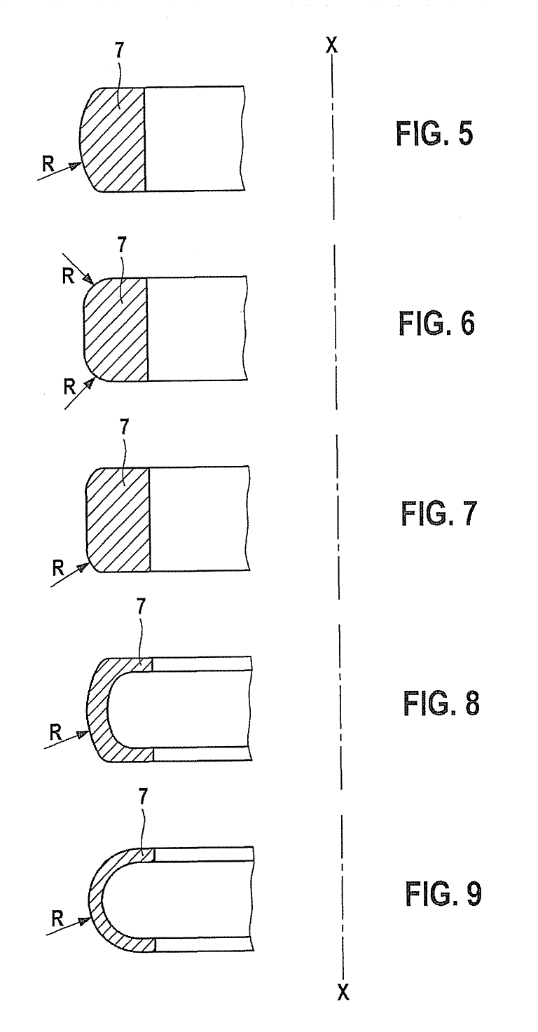

FIGS. 5 to 9 indicate five additional alternative exemplary embodiments of shielding rings 7, each having a radially outwardly rounded cross-section which is however not completely round. For example, shielding rings 7 shown in FIGS. 5, 6, and 7 each have, on their inner side oriented towards mid-axis X-X, a radially inner limiting wall that runs parallel to mid-axis X-X. The radially external limiting wall of shielding ring 7 either has a constant radius over its entire thickness (FIG. 5) or has only rounded corner areas whose roundings go over smoothly, with corresponding radii, from the radially external limiting wall to the upper and lower end faces (FIG. 6), or whose roundings go over, with corresponding radii, on the one hand tangentially to the radially external limiting wall and on the other hand non-tangentially to the upper and lower end faces (FIG. 7).

The exemplary embodiments of shielding rings 7 shown in FIGS. 8 and 9 are distinguished in particular in that they have a C-shaped profile that curves convexly radially outward, thus enclosing an open hollow space oriented towards mid-axis X-X. in these examples, shielding rings 7 are thus constructed in a manner similar to a bent, thin-walled sheet, and thus do not have a solid profile. FIG. 8 shows a shielding ring 7 that is fashioned with a varying wall thickness, while shielding ring 7 shown in FIG. 9 is fashioned with a constant wall thickness.

1-12. (canceled)

13. An internal combustion engine, comprising:
a combustion chamber;
a cylinder head;
a fuel injection valve adapted to inject fuel directly into the combustion chamber, the fuel injection valve situated in the cylinder head;
an annular sealing element arranged between the fuel injection valve and the cylinder head and adapted to seal the combustion chamber; and
a shielding ring arranged between the sealing element and the combustion chamber in an axial direction of the fuel injection valve;
wherein the shielding ring has at least one of (a) a round cross-section and (b) a cross-section that is rounded radially outwardly.

14. The internal combustion engine according to claim 13, wherein the shielding ring is made of at least one of (a) wire and (b) high-temperature-resistant plastic.

15. The internal combustion engine according to claim 13, wherein the shielding ring is arranged in a groove provided in the fuel injection valve.

16. The internal combustion engine according to claim 15, wherein the sealing element is arranged in a first groove provided in the fuel injection valve, and the shielding ring is arranged in a second groove provided in the fuel injection valve.

17. The internal combustion engine according to claim 13, wherein the shielding ring and the sealing element are arranged in a common groove, and at least one of (a) the shielding ring is arranged at a distance from the sealing element and (b) the shielding ring contacts the sealing element.

18. The internal combustion engine according to claim 13, wherein the shielding ring has at least one of (a) a closed annular shape and (b) an open annular shape.

19. The internal combustion engine according to claim 13, wherein the shielding ring is arranged partly in a groove provided in the cylinder head and partly in a groove arranged in the fuel injection valve.

20. The internal combustion engine according to claim 19, wherein the groove provided in the cylinder head and the groove provided in the fuel injection valve have at least one of (a) a same depth and (b) a depth corresponding to a radius of the shielding ring having a round cross-section.

21. The internal combustion engine according to claim 13, wherein a diameter of the shielding ring is equal to a thickness of the sealing element in a radial direction.

22. The internal combustion engine according to claim 13, wherein a radially external limiting wall of the shielding ring is rounded at least in a partial region, at least one of (a) a constant radius being provided over an entire thickness and (b) rounded corner areas being formed.

23. The internal combustion engine according to claim 13, wherein the shielding ring has a thin-walled C-shaped profile having a convex curvature that is oriented radially outwardly, inwardly enclosing an open hollow space.

24. The internal combustion engine according to claim 13, wherein an accommodating space is arranged on a side of the sealing element facing away from the combustion chamber to accommodate wear debris from the sealing element.
